(19) United States
(12) Patent Application Publication
(10) Pub. No.: US 2011/0286028 A1
(43) Pub. Date: Nov. 24, 2011

(54) IMAGE FORMING APPARATUS AND METHOD OF CONTROLLING IMAGE FORMING APPARATUS

(75) Inventors: Satoshi Kinouchi, Tokyo (JP); Toshihiro Sone, Kanagawa-ken (JP); Ryota Saeki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/110,506

(22) Filed: May 18, 2011

Related U.S. Application Data
(60) Provisional application No. 61/346,352, filed on May 19, 2010.

(51) Int. Cl. G06K 15/00; H04B 5/00; H04B 7/00

(52) U.S. Cl. 358/1.14; 455/41.2; 455/41.1

(57) ABSTRACT

According to one embodiment, an image forming apparatus includes a printer, a wireless device, an authentication information reader, an authentication device, and a processor. The printer forms an image on an image forming medium. The wireless device receives signals sent from an external device. The authentication information reader reads authentication information from a user operating the image forming apparatus. The authentication device authenticates the user by the authentication information read by the authentication information reader. If the wireless device receives signals sent from the external device, the processor starts warming up of the image forming unit, also, if the authentication device succeeds in user authentication, the processor causes the printer to form an image on the image forming medium in response to the user's request.

### CROSS-REFERENCE TO RELATED APPLICATIONS

This application is based upon and claims the benefit of priority from U.S. Provisional Application No. 61/346,352 filed on May 19, 2010; the entire contents of which are incorporated herein by reference.

### FIELD

Embodiments described herein relate generally to an image forming apparatus and a method of controlling the image forming apparatus.

### BACKGROUND

Conventionally, an image forming apparatus such as a digital multi-function printer needs warming up so as to be ready for printing, and warming up takes time. In order to reduce the waiting time taken for the warming up, an image forming apparatus which can efficiently perform warming up according to necessity is in demand.

### BRIEF DESCRIPTION OF THE DRAWINGS

FIG. 1 is a view schematically illustrating configuration example of a digital multi-function printer.

FIG. 2 is a block diagram illustrating a configuration example of a control.

FIG. 3 is a flowchart for describing security printing.

FIG. 4 is a flowchart for describing copying.

### DETAILED DESCRIPTION

In general, according to one embodiment, an image forming apparatus includes a printer, a wireless device, an authentication information reader, an authentication device, and a processor. The printer forms an image on an image forming medium. The wireless device receives signals sent from an external device. The authentication information reader reads authentication information from a user operating the image forming apparatus. The authentication device authenticates the user by the authentication information read by the authentication information reader. If the wireless device receives signals sent from the external device, the processor starts warming up of the image forming unit; also, if the authentication device succeeds in user authentication, the processor causes the printer to form an image on the image forming medium in response to the user's request.

Hereinafter, the embodiments will be described in detail with reference to the drawings.

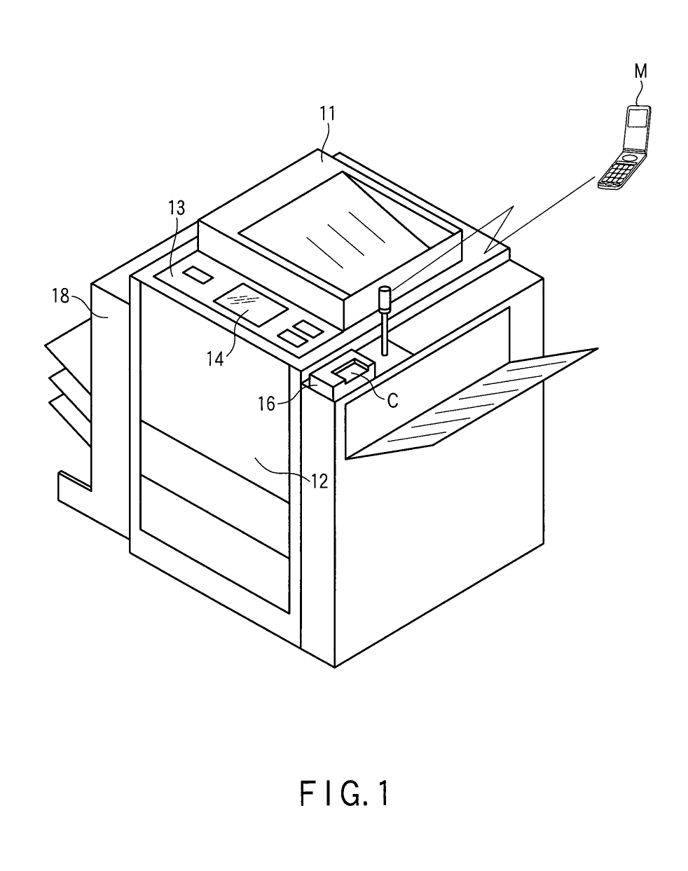

FIG. 1 is a view schematically illustrating a configuration example of an image forming apparatus 1.

A digital multi-function printer (MFP) 1 functions as an image forming apparatus. The digital multi-function printer 1 includes a scanner 11, a printer 12, an operation panel 13, a display device 14, a card reader 16, a wireless device 17, a finisher 18, and the like. By this configuration, the digital multi-function printer 1 performs the functions of scanning, printing, copying, network communication, user authentication, short-range wireless communication, and the like.

The scanner 11 converts an image on the surface of an original document into image data. For example, by optically scanning the surface of the original document, the scanner 11 reads the image on the surface of the original document as color image data or monochromic image data. The scanner 11 includes a scanning mechanism, a photoelectric conversion unit, an automatic document feeder (ADF), and the like.

The printer 12 forms an image on a recording medium such as paper. For example, the printer 12 forms the color image or a monochromic image on the paper. As the printer 12, printers forming images by using a printing method such as an electrophotographic method, an ink jet method, a thermal transfer method, or the like can be used. The digital multi-function printer of the embodiment includes a printer of the electrographic method. The finisher 18 is a device processing the paper printed by the printer 12.

The operation panel 13 and the display device 14 configure a user interface. The operation panel 13 includes various operation keys, for example. The display device 14 is configured with a display device including a built-in touch panel. The display device 14 displays an operation guide or icons that can be selected by using the touch panel, for example.

The card reader 16 is an authentication information reader reading the authentication information of a user. The card reader 16 reads the authentication information from an IC card C(or, from a portable terminal M having the equivalent function to the IC card) of the user. In the IC card C (or, the portable terminal M) of the user, the authentication information of the user as a card holder is recorded. Furthermore, the card reader 16 as the authentication information reader may read the authentication information from the user who operates the MFP 1. For example, instead of the card reader 16, a biometric information reader which reads the biometric information (for example, fingerprints, the pupil, a facial image, a vein pattern) of the user as the authentication information may be provided. In this case, the biometric information reader as the authentication information reader, which is used in place of the card reader 16, reads the user's own biometric information from the user who operates the MFP 1.

In the embodiment, the card reader 16 reads the authentication information while being close to or contacting the IC card C (or the portable terminal M having the equivalent function to the IC card) presented by the user who directly operates the MFP 1 (or by the user who is in front of the MFP 1). For example, if a near field communication method (a non-contact communication method) is used as the communication method of the card reader 16 and the IC card C, by the non-contact communication with the IC card C close to (for example, within 30 cm from the card reader 16), the card reader 16 reads the authentication information from the IC card C (or the portable terminal M). If the card reader 16 reads the authentication information only if the IC card C is close to the card reader 16 (for example, within 30 cm from the card reader 16), a user who presents the authentication information is specified as the user who directly operates the MFP 1.

The wireless device 17 is a device (not shown in FIG. 1) transmitting and receiving signals for short-range (proximity) wireless communication (a communication method which is different from that of at least the card reader 16). The wireless device 17 receives the signals for short-range wireless communication sent from a device (for example, the portable terminal M of the user) which is in a predetermined range of distance from the MFP 1. For example, if a communication method in which the short-range wireless communication is performed by using radio waves having a communication zone of about 3 to 10 meters is used, an antenna transmitting and receiving the radio waves configures the wireless device 17. Moreover, if an infrared communication method transmitting and receiving signals by infrared rays is used as the short-range wireless communication, an optical unit transmitting and receiving the infrared rays configures the wireless device 17.

Next, the configuration of a control system of the digital multi-function printer 1 will be described.

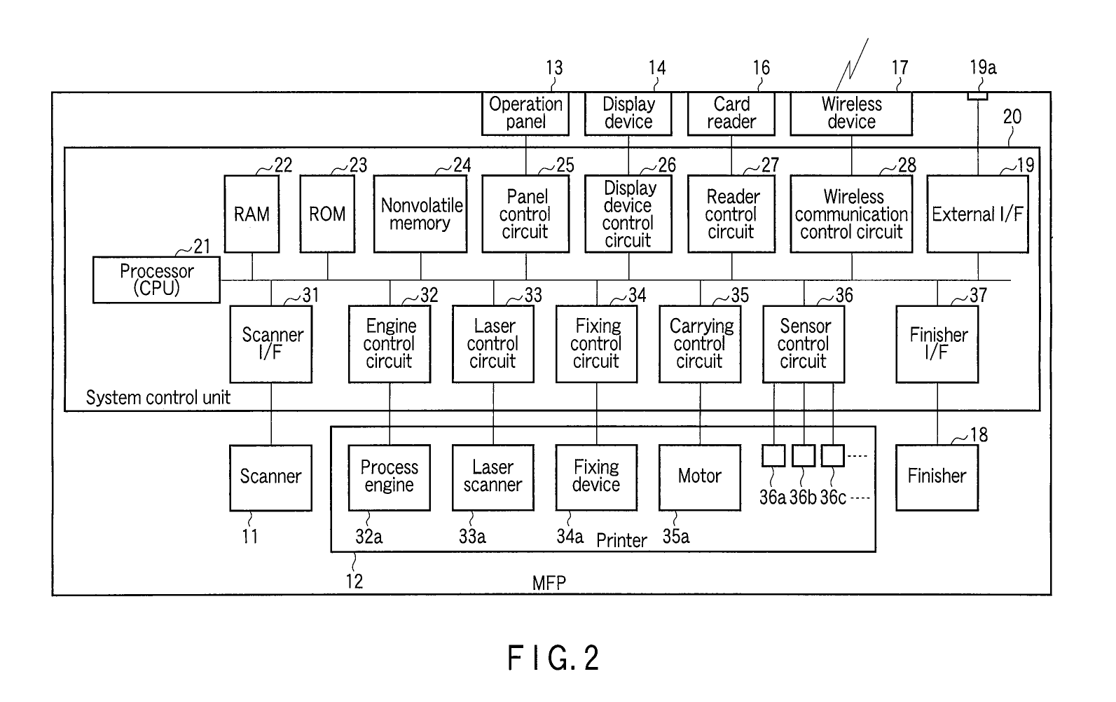

FIG. 2 is a block diagram illustrating the configuration example of the control system of the digital multi-function printer 1.

As shown in FIG. 2, the digital multi-function printer 1 includes a system control unit 20 having an external interface 19. The system control unit 20 generally controls respective units in the digital multi-function printer 1. The system control unit 20 is connected to the scanner 11, the printer 12, the operation panel 13, the display device 14, the card reader 16, the wireless device 17, and the finisher 18. For example, the system control unit 20 controls the scanner 11 to read the image of the original document set by the user. The system control unit 20 controls the printer to print the read image of the document on paper, thereby realizing the function of copy.

Furthermore, the system control unit 20 realizes the printing function of printing print data obtained through the external interface 19 on paper. The external interface (I/F) 19 is an interface for performing data communication between the MFP 1 and an external device. The external interface 19 is a network interface or an interface for locally connecting the external device, for example. In the digital multi-function printer 1 of the embodiment, a network interface for communicating with the user terminal through a local area network configures the external interface 19.

The external interface 19 receives the print data from the user terminal in which a printer driver program for the MFP 1 is installed, through the local area network. Based on the print data received from the user terminal, the system control unit 20 performs printing by the printer 12. As one of the functions of performing printing requested from the user terminal, the digital multi-function printer 1 has a function called security printing (also referred to as private printing) in which printing requested by the user is performed only for the user who succeeded in authentication by the authentication information read by the card reader 16.

As shown in FIG. 2, the system control unit 20 includes the external interface (I/F) 19, a processor (CPU) 21, a random access memory (RAM) 22, a read-only memory (ROM) 23, a nonvolatile memory 24, a panel control circuit 25, a display control circuit 26, a reader control circuit 27, a wireless communication control circuit 28, a scanner I/F 31, an engine control circuit 32, a laser control circuit 33, a fixing control circuit 34, a carrying control circuit 35, a sensor control circuit 36, a finisher I/F 37, and the like.

The processor 21 is a CPU, for example. By performing a control program stored in the ROM 23 and the nonvolatile memory 24, the processor 21 realizes various processing functions. The RAM 22 is a main memory that functions as a working memory. The ROM 23 stores the control program and the control data controlling the operation of the digital multi-function printer 1. The nonvolatile memory 24 is a rewritable nonvolatile memory. The nonvolatile memory 24 stores the control program and the control data for realizing various processing functions. For example, the nonvolatile memory 24 stores information indicating the machine setting of the digital multi-function printer 1. The nonvolatile memory 24 may store the image data read by the scanner 11 or the print data including the image data received through a network.

The panel control circuit 25 controls the operation panel 13. The panel control circuit 25 provides the information input in the operation panel 13 to the processor 21. The display control circuit 26 controls the display content that the display device 14 displays. According to the control command from the processor 21, the display control circuit 26 controls the display device 14 to display the operation guide or icons that the user can select by using the touch panel.

The reader control circuit 27 controls the card reader 16. The reader control circuit 27 controls the card reader 16 to read the authentication information of the user. Herein, in the IC card C (or in the portable terminal M having the equivalent function to the IC card), the authentication information of the user is recorded. By a contact type or near field communication, the card reader 16 reads the authentication information from the IC card C (or from the portable terminal M). That is, the reader control circuit 27 controls the card reader 16 to read the authentication information from the IC card C (or from the portable terminal M) of the user. The reader control circuit 27 provides the authentication information read by the card reader 16 to the processor 21.

The wireless communication control circuit 28 is connected to a wireless device 17 for transmitting and receiving signals used for the short-range wireless communication. For example, if the short-range wireless communication is the wireless communication using radio waves, the wireless communication control circuit 28 controls the radio waves transmitted and received by an antenna as the wireless device 17. Furthermore, if the short-range wireless communication is the wireless communication (infrared communication) using infrared rays, the wireless communication control circuit 28 controls the infrared rays transmitted and received by an optical unit as the wireless device 17. Moreover, the wireless communication control circuit 28 has a function of determining the intensity of the signals received by the wireless device 17. The wireless communication control circuit 28 provides the intensity of the received signals as well as the information included in the signal received by the wireless device 17 to the processor 21.

The external interface (I/F) 19 is an interface for performing the data communication between the MFP 1 and an external device. The external interface 19 is a network interface or an interface for locally connecting the external device, for example. In the embodiment, the network interface for communicating with the user terminal through the local area network configures the external interface 19. From the user terminal in which the printer driver program for the MFP 1 is installed, the external interface 19 receives the print data requesting printing, through the local area network.

The scanner I/F 31 is connected to the scanner 11. The processor 21 controls the scanner 11 through the scanner I/F 31, thereby performing scanning of reading the image of the original document. The finisher I/F 37 is connected to the finisher 18 processing the printed paper output from the printer 12. The processor 21 controls the finisher 18 through the finisher I/F 37.

The engine control circuit 32, the laser control circuit 33, the fixing control circuit 34, and the carrying control circuit 35 are respectively connected to a process engine 32a, a laser scanner 33a, a fixing device 34a, and a carrying mechanism 35a in the printer 12. Furthermore, the sensor control circuit 36 is connected to sensors 36a, 36b, and the like provided in the printer 12. Based on detection signals of the sensors 36a, 36b, and the like, which are received through the sensor control circuit 36, the processor 21 controls the engine control circuit 32, the laser control circuit 33, the fixing control circuit 34, and the carrying control circuit 35, thereby performing printing by the printer 12.

The carrying mechanism 35a carries paper as an image forming medium. The laser scanner 33a forms an electrostatic latent image on an image carrier such as the photoconductive drum. The process engine 32a applies a developer to the electrostatic latent image formed on the image carrier such as a photoconductive drum, thereby forming a developer image. The developer image on the photoconductive drum is transferred to the paper as the image forming medium through an intermediate transfer body such as a transfer belt. The developer image on the photoconductive drum may be so configured such that the developer image is directly transferred to the paper as the image forming medium.

The fixing device 34a fixes the developer image to the paper to which the developer image has been transferred. The fixing device 34a heats a fixing member such as a fixing roller by using heat sources including a heating lamp such as a halogen lamp, an IH heater, or the like. By using the heated fixing member, the fixing device 34a heats and melts the developer on the paper, thereby fixing the developer on the paper. The fixing device 34a requires warming up to heat the fixing member to a desired control temperature that is suitable for fixing. For example, the digital multi-function printer 1 has a sleep mode as an operation mode of the printer. If the operation mode is in the sleep mode, power supply to the heat source in the fixing device 34a is stopped. Accordingly, if the operation mode returns from the sleep mode, the fixing control circuit 34 performs warming up to heat the fixing member of the fixing device 34a to a desired control temperature.

In other words, in the image formation, the fixing control circuit 34 warms up the fixing member of the fixing device 34a to a desired control temperature. The control temperature with respect to the fixing device 34a can be set to the value in accordance with the image formation mode. For example, in color printing, the control temperature is set to the control temperature for color printing, which is higher than that for monochromic printing. In the embodiment, the control temperature for monochromic printing in the monochromic printing is the lowest control temperature among the settable control temperatures.

Next, security printing performed by the digital multi-function printer 1 will be described.

In the embodiment, the digital multi-function printer 1 has a function of network printing in which the print data received through a network is printed. Moreover, the function of network printing includes a security printing function (which is also referred to as private printing) in which printing requested by the user is performed if the digital multi-function printer 1 succeeds in authentication by using the card of the user.

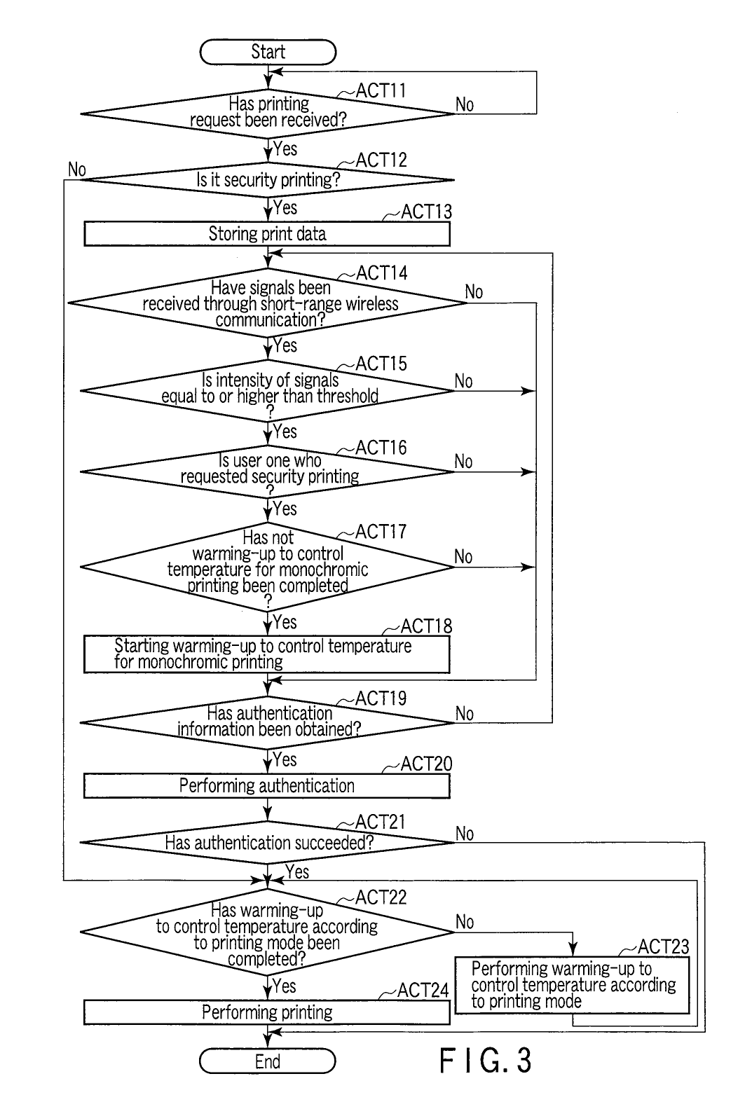

FIG. 3 is a flowchart for describing the flow of security printing.

The processor 21 determines whether or not print request (print data) from an external device connected through the external interface 19 has been received. If the print request has been received through the external interface 19 (ACT 11, YES), the processor 21 determines whether or not the received print request is for the security printing which requires authentication by the user (ACT 12). If the received print request is not for the security printing (ACT 12, NO), the processor 21 warms up the control temperature of the fixing device 34a to a control temperature in accordance with the printing mode, thereby performing printing.

The processor 21 determines the control temperature of the warming up with respect to the fixing device 34a according to the printing mode of the received print data. After determining the control temperature of the warming up, the processor 21 determines whether or not the warming up is necessary (ACT 22). For example, according to whether or not the current temperature in the fixing device 34a is equal to or higher than the control temperature, the processor 21 determines whether or not the warming up is necessary. If it is determined that the warming up is necessary (ACT 22, NO), the processor 21 performs the warming up to heat the fixing device 34a to the control temperature in response to the print request (ACT 23). If it is determined that the warming up is unnecessary, or, if it is determined that the warming up has been completed (ACT 22, YES), the processor 21 operates the respective units of the printer 12 and prints the image data requested to be printed on paper (ACT 24).

If the print request received by the external interface 19 is for the security printing (ACT 12, YES), the processor 21 stores the print data received by the external interface 19 to the nonvolatile memory 24 (ACT 13). In the embodiment, the print data of the security printing includes the image data to be printed and the authentication information for user authentication.

If the print data of the security printing is received, the processor 21 starts warming up in response to the signals received by the wireless device 17 through the short-range wireless communication. In the embodiment, if the signals sent through the short-range wireless communication from the portable terminal M of the user of the security printing are received with predetermined reception intensity, the warming up is started. For example, the portable terminal M of the user includes a function of outputting the signals including the user ID through the short-range wireless communication. The signals including the user ID are signals requesting starting of the warming up. The signals requesting the starting of the warming up are output from the portable terminal M in response to the operation performed by the user. Furthermore, the portable terminal M may always output the signals including the user ID.

The fixing device 34a is warmed up to various control temperatures set according to the operation mode. In the embodiment, the warming up in response to the signals received through the short-range wireless communication is performed at the lowest control temperature (a first control temperature) among the control temperatures that can be set in the fixing device 34a. The lowest temperature as the control temperature of the fixing device 34a is taken as the control temperature for monochromic printing. That is, in the embodiment, the warming up in response to the signals received through the short-range wireless communication warms up the fixing device 34a to the control temperature for monochromic printing.

The processor 21 determines whether or not the wireless device 17 has received signals through the short-range wireless communication (ACT 14). If the wireless device 17 had received the signals through the short-range wireless communication (ACT 14, YES), the processor 21 determines whether or not the intensity of the received signal is equal to or higher than a predetermined threshold (ACT 15). The signal intensity determination is made on the assumption that the distance between the portable terminal M as the source of sending the signals and the MFP 1 is determined. The intensity of signals (radio waves or infrared rays) used for the short-range wireless communication varies with the distance. Accordingly, for example, in order to start the warming up if the distance between the portable terminal M and the MFP 1 is 3 to 5 meters, the intensity of signals received in 3 to 5 meters is set as the threshold.

If it is determined that the intensity of the signals received by the wireless device 17 is equal to or higher than a predetermined threshold (ACT 15, YES), the processor 21 determines whether or not the user who sent the signals is the user who requested the security printing (ACT 16). For example, whether or not the user is the one who requested the security printing is determined by the user ID included in the received signals. In this case, the processor 21 determines whether or not the user ID included in the print data received as the data for the security printing coincides with the user ID included in the signals received by the wireless device 17.

The process in ACT 16 may be omitted. If the signals are received with an intensity equal to or higher than a predetermined intensity through the short-range wireless communication, the processor 21 may perform the warming up to the control temperature for the monochromic printing, without checking the user who sent the signals received by the wireless device 17.

If it is determined that the user who sent the signals received by the wireless device 17 is the user who requested the security printing (ACT 16, YES), the processor 21 determines whether or not the warming up to the control temperature for monochromic printing has not been completed (ACT 17). For example, if the fixing device 34a is already at the control temperature for the monochromic printing, the processor 21 determines that the warming up has been completed (ACT 17, NO).

If it is determined that the warming up has not been completed (ACT 17, YES), the processor 21 starts to warm up the fixing device 34a to the control temperature for the monochromic temperature (ACT 18). The processor 21 outputs the warming up control signals to the fixing control circuit 34 to make the control temperature for the monochromic printing, whereby the warming up is performed.

In the MFP 1 which has received the print data of the security printing, the card reader 16 reads the authentication information of the user who directly operates the MFP 1 (the user in front of the MFP 1). The card reader 16 reads the authentication information from the IC card (or the portable terminal M) presented by the user who directly operates the MFP 1. For example, if the authentication information is read from a non-contact type of IC card, the card reader 16 reads the authentication information from the IC card (or from a portable terminal having the equivalent communication function to the non-contact type of IC card) presented by the user within a range of 30 cm. Furthermore, the non-contact type of IC card is used for the near field communication performed within a communication distance of about 30 cm.

The processor 21 determines whether or not the authentication information presented by the user has been read (ACT 19). If the authentication information presented by the user has been read (ACT 19, YES), the processor 21 authenticates whether or not the authentication information read by the card reader 16 (the authentication information presented by the user in front of the MFP 1) coincides with the authentication information of the user who requested the security printing (ACT 20). The authentication information of the user who requests the security printing may be registered on the database provided in the nonvolatile memory 24 or a server that can communicate through an external I/F; also, the authentication information may be transmitted to the MFP 1 together with the print data of the security printing. If answers for ACT 14 to 17 are NO, the process moves on to ACT 19. Furthermore, if the processor 21 determines that the answer for ACT 19 is NO, the process returns to ACT 14.

The processor 21 determines whether or not the authentication of the user who requested the security printing has succeeded (ACT 21). If the authentication of the user who requested the security printing has succeeded (ACT 21, YES), the processor 21 performs the security printing (ACT 22 to 24). That is, the processor 21 determines whether or not the fixing device 34a has been warmed up to the control temperature in accordance with the operation mode of the security printing (ACT 22). If it is determined that the warming up to the control temperature in accordance with the operation mode of the security printing has not been completed (ACT 22, NO), the processor 21 performs the warming up to the control temperature in accordance with the operation mode of the security printing (ACT 23). Furthermore, if it is determined that the warming up to the control temperature in accordance with the operation mode of the security printing has been completed (ACT 22, YES), the processor 21 performs the security printing (ACT 24). If the processor 21 determines that the answer for ACT 21 is NO, the flow in FIG. 3 ends.

As described above, the digital multi-function printer of the embodiment separately includes a second communication function (a wireless device) receiving signals for starting warming up, in addition to a first communication function (a card reader) for obtaining the authentication information of the user, in the security printing. The signals that the digital multi-function printer receives by the second communication function are sent by the function of short-range wireless communication included in the portable terminal such as a mobile phone of the user.

In this manner, before reading the authentication information presented by the user, the digital multi-function printer of the embodiment can start warming up in response to the signals received by the second communication function. As a result, the user can reduce the time taken for the warming up performed after the digital multi-function printer reads the authentication information and thus can reduce the time spent while waiting in front of the digital multi-function printer. Moreover, since the waiting time can be shortened even in the sleep mode, the need for constantly warming up the machine in advance is reduced. Accordingly, the operation of shifting the digital multi-function printer to the sleep mode in a short period of time can be easily performed, so it is possible to promote power saving.

As the second communication function provided in the digital multi-function printer, it is possible to apply the communication functions included in a mobile phone or the like that the user already has. Accordingly, even if the user does not specially prepare a new device including the second communication function, it is possible to easily operate the digital multi-function printer to realize the warming up control described above. That is, it is possible to easily create an operating environment where the process described in the embodiment can be performed with low cost.

Moreover, if the warming up is started in response to the signals received by the second communication function, the digital multi-function printer of the embodiment performs the warming up at a low control temperature such as the control temperature for monochromic printing. If printing is actually performed after the warming up is performed at a low temperature, if it is necessary to perform the warming up at the higher control temperature (for example, at the control temperature for color printing) in accordance with the printing mode, the digital multi-function printer adds and performs the warming up operation. As a result, wasteful thermal energy consumption which results from the warming up in response to the signals received by the second communication function can be inhibited; accordingly, it is possible to provide the digital multi-function printer which efficiently consumes the thermal energy.

Next, copying including the warming up in response to the signals received through the short-range wireless communication will be described.

The warming up in response to the signals received through the short-range wireless communication as described above may be performed not only for the security printing but in a copy standby state. That is, the digital multi-function printer in the sleep mode as the copy standby state may be warmed up by the signals sent from the portable terminal M of the user through the short-range wireless communication, even if the machine does not perform the security printing.

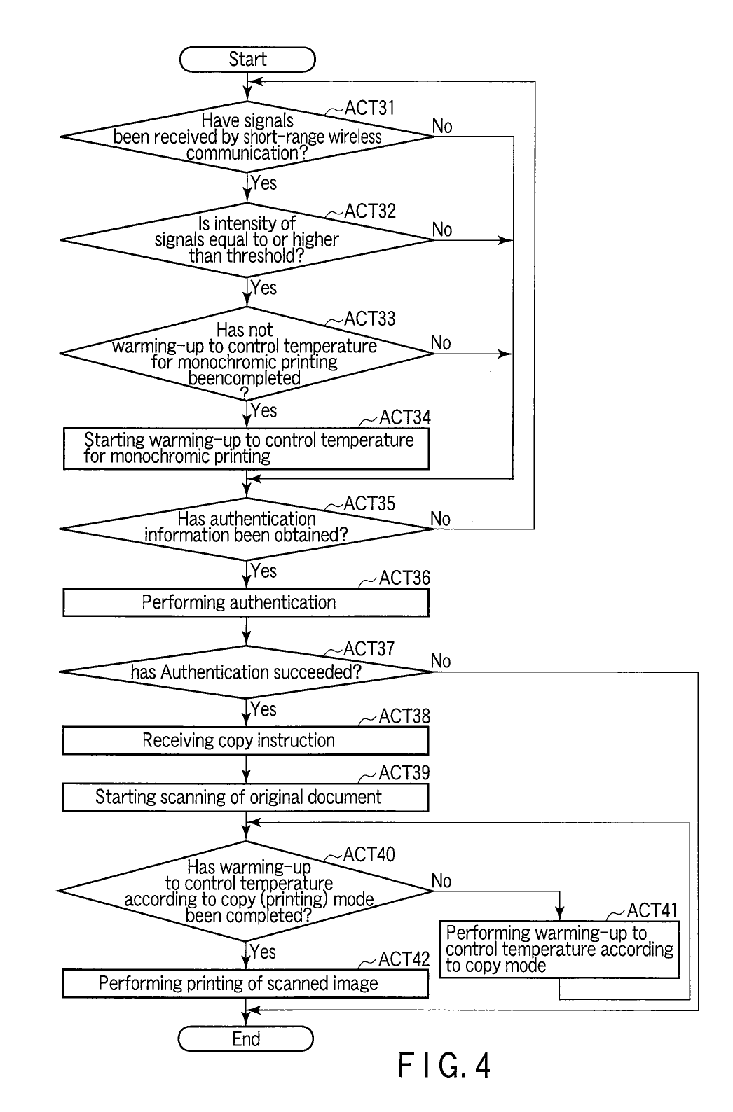

FIG. 4 is a flowchart for describing the flow of copying including the warming up in response to the signals received through the short-range wireless communication.

In the copy standby state, the digital multi-function printer 1 is in a state where the wireless device 17 can receive the signals through the short-range wireless communication. The processor 21 determines whether or not the wireless device 17 has received the signals through the short-range wireless communication (ACT 31). If the wireless device 17 has received the signals through the short-range wireless communication in this state (ACT 31, YES), the processor 21 determines whether or not the intensity of the received signals is equal to or higher than a predetermined threshold (ACT 32). The signal intensity determination is made on the assumption that the distance between the portable terminal M as the source of sending the signals and the MFP 1 is determined. For example, in order to start the warming up if the distance between the portable terminal M of the user and the MFP 1 is 3 to 5 meters, the intensity of signals received in 3 to 5 meters is set as the threshold.

If it is determined that the intensity of the signals received by the wireless device 17 is equal to or higher than a predetermined threshold (ACT 32, YES), the processor 21 determines whether or not the warming up to the control temperature in response to the signals received through the short-range wireless communication has not been completed (ACT 33). For example, if the fixing device 34a is already at the control temperature for the monochromic printing, the processor 21 determines that the warming up has been completed (ACT 33, NO).

If it is determined that the warming up has not been completed (ACT 33, YES), the processor 21 starts to warm up the fixing device 34a to the control temperature for the monochromic printing (ACT 34). The processor 21 outputs the warming up control signals to the fixing control circuit 34 to set to the control temperature for the monochromic printing, whereby the warming up is performed.

Furthermore, the card reader 16 of the digital multi-function printer 1 reads the authentication information of the user (who is in front of the MFP 1) directly operating the MFP 1. That is, the card reader 16 reads the authentication information from the IC card C (or from the portable terminal M) presented by the user directly operating the MFP 1. For example, if the authentication information is read from a non-contact type of IC card, the card reader 16 reads the authentication information from the IC card C (or from the portable terminal M having the equivalent function to the non-contact type of IC card) presented by the user within a range of a close distance (for example, within 30 cm). Furthermore, the non-contact type of IC card is used for the near field communication performed within a communication distance of about 30 cm.

The processor 21 determines whether or not the authentication information presented by the user has been read (ACT 35). If the authentication information presented by the user has been read (ACT 35, YES), the processor 21 checks whether or not the authentication information read by the card reader 16 coincides with the authentication information of the user who has a copying authority (ACT 36). The authentication information of the user who has the copying authority may be registered on a database provided in the nonvolatile memory 24 or on a server that can communicate through the external interface 19. If the processor 21 determines that the answers for ACT 31 to 33 are NO, the process moves on to ACT 35. Furthermore, if the processor 21 determines that the answer for ACT 35 is NO, the process returns to ACT 31.

The processor 21 determines whether or not the user authentication has succeeded (ACT 37). If the user authentication has succeeded (ACT 37, YES), the processor 21 receives the input of the copy instruction by the operation panel 13 (ACT 38).

For example, the user gives an instruction to start warming up by using the portable terminal M from a location separated (2 to 3 meters, for example) from the digital multi-function printer 1 and moves to the digital multi-function printer 1. Then, the digital multi-function printer 1 receives the signals sent from the portable terminal M through the short-range wireless communication and starts warming up. In this case, if the user has reached the digital multi-function printer, the digital multi-function printer has already started the warming up (or the warming up has been completed).

The user who has reached the digital multi-function printer performs user authentication by touching the IC card C storing the authentication information to the card reader 16. If the user authentication succeeds, the copy instruction can be input by the operation panel 13. In this state, the user sets an original document in the scanner 11 of the digital multi-function printer 1 and provides an instruction to start copying by using the operation panel 13. In this manner, in the digital multi-function printer 1, after the warming up is started prior to the user authentication or the like, the copy request by the user can be received.

If the copy request input to the operation panel 13 is received, the processor 21 starts scanning of the original document by using the scanner 11 (ACT 39). If the copy request is received, the processor 21 causes the scanner 11 to scan the original document and determines the control temperature of warming up in accordance with the copy (printing) mode at the same time. After determining the control temperature of warming up in accordance with the copy mode, the processor 21 determines whether or not the warming up to the control temperature in accordance with the copy mode is necessary (ACT 40).

If it is determined that the warming up to the control temperature in accordance with the copy mode has not been completed (ACT 40, NO), the processor 21 performs the warming up to the control temperature in accordance with the copy mode (ACT 41). Moreover, if the warming up to the control temperature for monochromic printing in response to the signals received through the short-range wireless communication has not been completed in ACT 41, the processor 21 changes the control temperature of the warming up to the control temperature in accordance with the copy mode and continues the warming up. Further, if it is determined that the warming up to the control temperature in accordance with the copy mode has been completed (ACT 40, YES), the processor 21 prints (copy prints) the image of the original document read by the scanner 11 on paper (ACT 41). If the processor 21 determines that the answer for ACT 37 is NO, the flow in FIG. 4 ends.

As described above, the digital multi-function printer of the embodiment can start warming up in response to the signals sent by the short-range wireless communication function included in the portable terminal such as a mobile phone of the user, not only in the security printing, but in the copy standby state. Therefore, according to the embodiment, before the user who wants to perform copying with the digital multi-function printer in sleep mode moves to the digital multi-function printer (for example, while the user is moving), it is possible to start the warming up in advance. Therefore, it is possible to shorten the waiting time for which the user waits in front of the digital multi-function printer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a printer which forms an image on an image forming medium;
a wireless device which receives signals sent from an external device;
an authentication information reader which reads the authentication information from a user who operates the image forming apparatus;
an authentication device which authenticates the user by using the authentication information read by the authentication information reader; and
a processor which starts warming up of the printer if the wireless device receives the signals sent from the external device and forming an image on the image forming medium by using the printer in response to a request of the user if the authentication device succeeds in the user authentication.

2. The apparatus according to claim 1,
wherein the wireless device receives the signals by a method of short-range wireless communication.

3. The apparatus according to claim 2,
wherein the wireless device receives the signals by a method of infrared communication using infrared rays.

4. The apparatus according to claim 2,
wherein the wireless device receives the signals by a method of short-range wireless communication using radio waves.

5. The apparatus according to claim 2,
wherein the processor starts the warming up of the printer if the intensity of the signals received by the wireless device is equal to or higher than a threshold.

6. The apparatus according to claim 1,
wherein the authentication information reader is a card reader reading the authentication information from an IC card storing the authentication information of the user.

7. The apparatus according to claim 1,
wherein the authentication information reader reads the authentication information from a portable terminal device storing the authentication information of the user by a near field communication.

8. The apparatus according to claim 7,
wherein the wireless device receives the signals by the method of short-range wireless communication having a broader communication range compared to the near field communication.

9. The apparatus according to claim 1,
wherein the processor performs a first warming up warming the inside of the printer to a first control temperature, and
the processor forms the image after performing a second warming up warming the inside of the printer to the second control temperature, if the image formation requested by the user is performed at a second control temperature higher than the first control temperature.

10. The apparatus according to claim 1,
wherein the printer is a printer of an electrophotographic method.

11. An image forming apparatus comprising:
a printer which forms an image on an image forming medium;
a wireless device which receives signals sent from an external device;
an authentication information reader which reads the authentication information from a user who operates the image forming apparatus; and
a controller which starts warming up of the printer if the signals are received by the wireless device to perform user authentication by using the authentication information read by the authentication information reader and forming an image on the image forming medium by using the printer in response to a request of the user if the user authentication is succeeded.

12. A method of controlling an image forming apparatus, the method comprising:
receiving signals sent from an external device by wireless communication;
starting warming up in response to the reception of the signals sent from the external device;
reading authentication information from a user who operates the image forming apparatus;
performing user authentication by using the authentication information read from the user who operates the image forming apparatus; and
forming an image on an image forming medium in response to a request of the user if the user authentication is succeeded.

13. The method according to claim 12,
wherein the wireless communication is short-range wireless communication having a communication zone of a predetermined distance range.

14. The method according to claim 13,
wherein the wireless communication is infrared communication using infrared rays.

15. The method according to claim 13,
wherein the wireless communication is short-range wireless communication using radio waves.

16. The method according to claim 13,
wherein the warming up is performed if the intensity of the signals received by the wireless device is equal to or higher than a threshold.

17. The method according to claim 12,
wherein the authentication information is read from an IC card storing the authentication information of the user.

18. The method according to claim 12,
wherein the authentication information is read from a portable terminal device storing the authentication information of the user by a near field communication.

19. The method according to claim 18,
wherein the wireless communication is a method of short-range wireless communication having a broader communication range compared to the near field communication.

20. The method according to claim 12,
wherein warming up started in response to the reception of the signals sent from the external device is a process of making a first control temperature; and
the image formation is performed after warming up making the second control temperature is additionally performed, if the image formation requested by the user is performed at a second control temperature higher than the first control temperature.
